(19) United States
(12) Patent Application Publication
(10) Pub. No.: US 2015/0099082 A1
(43) Pub. Date: Apr. 9, 2015

(54) PRINTED LABELS AND METHOD OF MAKING SAME

(71) Applicant: Frederic LaBRIE, Boucherville (CA)

(72) Inventor: Frederic LaBRIE, Boucherville (CA)

(21) Appl. No.: 14/505,832

(22) Filed: Oct. 3, 2014

Related U.S. Application Data
(60) Provisional application No. 61/886,704, filed on Oct. 4, 2013.

(51) Int. Cl. G09F 3/02; B32B 37/24; C09J 5/00; B32B 37/12

(52) U.S. Cl. CPC G09F 3/02; B32B 37/1292; B32B 37/24; C09J 5/00; G09F 2003/0202; G09F 2003/023; G09F 2003/0241; G09F 2003/0247; B32B 2037/243
USPC 428/41.8; 427/208; 156/264

(57) ABSTRACT

A method of producing stacks of printed, ready-to-use adhesive-backed labels which are separated from one another by release coatings that are in registry with adhesive strips but on opposite sides of each individual label to prevent the labels in the stack from adhering to one another to an excessive degree; i.e., to permit the labels to be separated from one another for application to the edge or face of a storage shelf. The overall production process may be carried out into different stations at different locations, the first location producing feed stock for the second location.

### CROSS-REFERENCE TO RELATED APPLICATION

This application claims the benefit of U.S. provisional patent application Ser. No. 61/886,704 filed Oct. 4, 2013.

### FIELD OF THE INVENTION

This application relates to the design and manufacture of adhesive labels from strip stock moving through a multi-station machine or sequence of machines.

### BACKGROUND OF THE INVENTION

Printed adhesive-backed labels are commonly used on retail store shelves to convey information to customers regarding products stored and displayed on the shelves. Because products, product locations and prices change often, such labels are frequently applied, removed, and replaced with new labels.

Many prior art shelf labels are manufactured using pre-made, pressure sensitive materials, of which many are available in the marketplace. These labels are made with an attached release liner that is typically thick to keep the product flat and allow the labels to feed through a laser printer without jamming. Part of the release liner is peeled off by an end user or, conversely, the labels are peeled off of the liner when applied.

Flatness is important because it allows the labels to stick to and/or hang from a shelf face in a store in such a way as to make it easy for customers to read information on the labels.

A thick release liner creates waste and makes labels, when packaged in substantial numbers, very heavy. This increases shipping costs and can induce curl, which is undesirable for the reasons set forth above.

Some prior art labels use delamination/relamination to create specific zones of adhesion.

The prior art can be used to produce finished labels in sheets or strips containing multiple labels and arranged in columns or rows. These sheets can be cumbersome in that a person applying the labels needs to disassemble the sheets into individual labels and apply the labels one at a time to the faces of the shelves. This process is time consuming and expensive because it is typically done by unskilled labor when the store is closed.

The prior art teachings also use laser printing to digitally print the various information on the labels. Because of this, heat resistant materials, flat laying materials, and good toner adhesion properties are needed. This limits the type of material which can be used to make labels and, with some printers, the labels are limited to black and white. A typical material used to make the labels is vinyl, which has environmental disadvantages.

### SUMMARY OF THE INVENTION

The present disclosure provides a teaching as to how to make adhesive-backed labels economically and efficiently in strip form and in ready-to-use stacks wherein multiple adhesive-backed printable or pre-printed labels lie on top of each other with a release coating between the labels directly beneath and geometrically coextensive with the adhesive layer on an adjacent label. The stack of labels from the process can be quickly and easily used by retail store personnel to apply labels to the faces or edges of product storage shelves.

In broad terms, the method can comprise a number of steps of making a strip or a stack of adhesive-backed labels from strip stock wherein the strip stock comprises printable flexible sheet material having first and second opposed sides. The steps comprise (a) applying discreet layers of adhesive to a first side of the stock in single or multiple rows at regularly spaced intervals wherein the layers are identical in area, geometry and orientation. As shown herein, the strip stock can be wide enough to make multiple rows of labels simultaneously.

Another step of the process involves the application of discreet layers of silicone-based release coating at regularly spaced intervals along another side of the strip stock in single or multiple rows, the discreet release coating layers also being of identical area, geometry and orientation to one another.

When these two steps are completed and the labels are cut from the stock and stacked, the regularly spaced layers of adhesive and release coating are essentially coextensive in that they lie on opposite sides of the sheet stock but geometrically correspond with one another.

The method may also involves steps of curing the release layer, identifying the position of each label by reference to one or both of the location of the edges of the adhesive and release coatings and the printing and, using the location information, arranging a cutter so as to cut the labels from the stock at the appropriate place.

In general, this sequence of steps further comprises a stacking step which results in a stack of labels which are easily peeled from one another and immediately applied to the edges or faces of shelves. As will hereinafter be made clear, the overall method can be divided into two parts carried out in sequence either at the same or in different locations. The first of the divided phases may result in a roll of strip stock with adhesive and cured release areas applied. This roll is then transported to the machinery involved in the next phase and unrolled wherein the remainder of the steps are carried out. Printing may occur at either of the two locations.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE FIGURES

The description herein makes reference to the accompanying drawings wherein like reference numerals refer to like parts throughout the several views and wherein:

FIG. 1 is a front plane view of an individual label;

FIG. 2 is a back plane view of the label of FIG. 1;

FIG. 3 is a front plane view of another individual label;

FIG. 3A is a side view of the label of FIG. 3;

FIG. 4 is a perspective view of a stack of labels made in accordance with this invention;

FIG. 5 is a sectional view through a portion of the stack of labels;

FIG. 6 shows how a label made in accordance with this invention may be applied to a shelf;

FIG. 7 is a process machinery diagram in perspective showing the movement of strip stock 50 from a roll 52 through multiple stations of a complete processing line;

FIG. 8 is a block diagram of the process carried out by the machinery in FIG. 7;

FIG. 9 is a system diagram of a first portion of a split, sequentially used set of machinery;

FIG. 10 is a second process equipment diagram or drawing in perspective showing the second set of equipment used in a split sequence of manufacturing labels in accordance with the present teaching; and

FIG. 11 is a detailed drawing of a portion of the system of FIG. 7.

### DETAILED DESCRIPTION

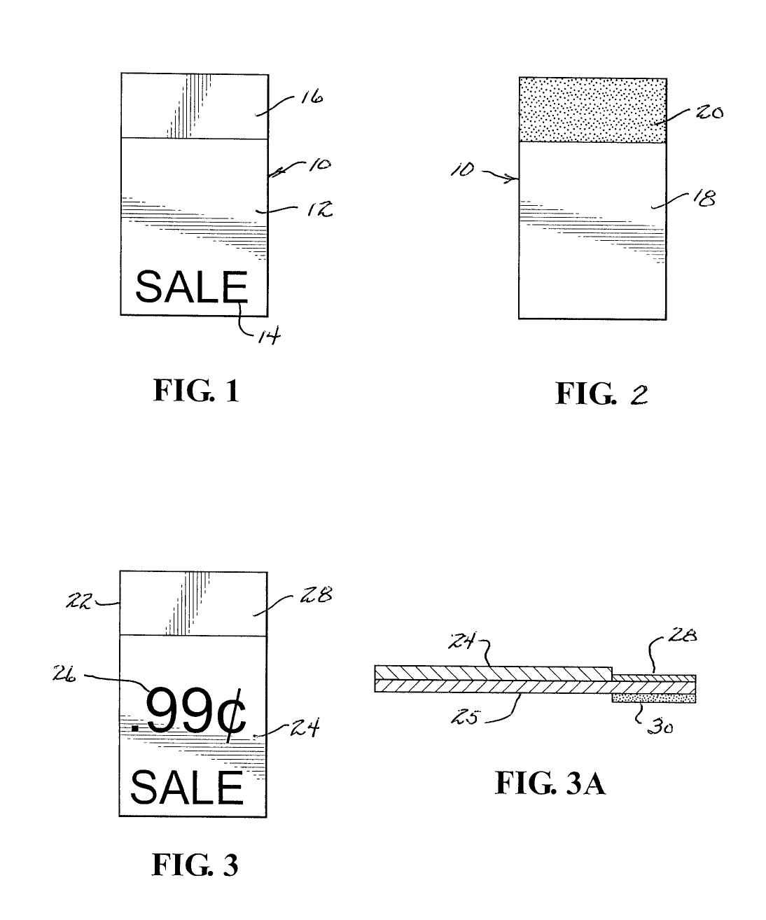

FIG. 1 shows a front plane view of an individual label 10. Label 10 may be of any shape and/or size but is shown in essentially rectangular form with dimensions of approximately 5×12 cm. and designed to be applied to the front face of a shelf 34 and hang essentially vertically in the orientation shown in FIGS. 1 and 6. In one embodiment, approximately the lower three quarters of a front face of label 10 is covered with an inkjet coating 12 which readily receives flexo printing 14. In one embodiment, an inkjet printing method is used to print on label 10. In alternative embodiments, other printing methods, such as electrophotography, dry toner, thermal transfer, and direct thermal printing are used. Label 10 is printed using digital technology 26. The top quarter of the front face of the label 10 is covered with a release coating 16. In one embodiment as shown in FIG. 2, approximately the back three quarters of a face stock 18 of label 10 is uncoated and approximately the top one quarter is covered with a pressure sensitive adhesive 20. In alternative embodiments, the ratio of area that label 10 is covered with adhesive 20, the release coating 16, or printed on may vary. The face stock 18 may be the any of a variety of materials, including white or colored opaque paper or a polymer film which can be clear, white, or colored. The materials have sufficient strength to not be easily cut, yet are flexible and light. In FIGS. 1 and 2, there is no liner attached or otherwise applied to either the front or the back face of the face stock 18 of label 10.

The optional inkjet coating can be water-based, applied by roller, and dried. Adhesive 20 may be any of a wide variety of available materials which are pressure sensitive and self-adhesive, such as various acrylics and hotmelts.

In an alternative embodiment, FIGS. 3 and 3A show a slightly different label 22 with the same shape and size as label 10 shown in FIGS. 1 and 2. Label 22 can be made of an opaque material. An inkjet coating 24 is applied to approximately the lower three quarters of a face stock to receive thereafter an inkjet/digital printing 26 in a readily readable form and size. A release coating 28 is applied to approximately the top quarter of the face stock with a sharp straight border relative to the inkjet coating 24. FIG. 3A shows the side view of label 22, such that the adhesive coating 30 on approximately the back top quarter of a face material 25 is directly opposite and identical in area to the release coating 28. In one embodiment, the inkjet coating 24 is located over approximately the bottom three quarters of the front of the face stock. The references to “one quarter” and “three quarters” are approximate and are not intended in a limiting sense. The figures may, for example, be one third and two thirds or other fractions as desired.

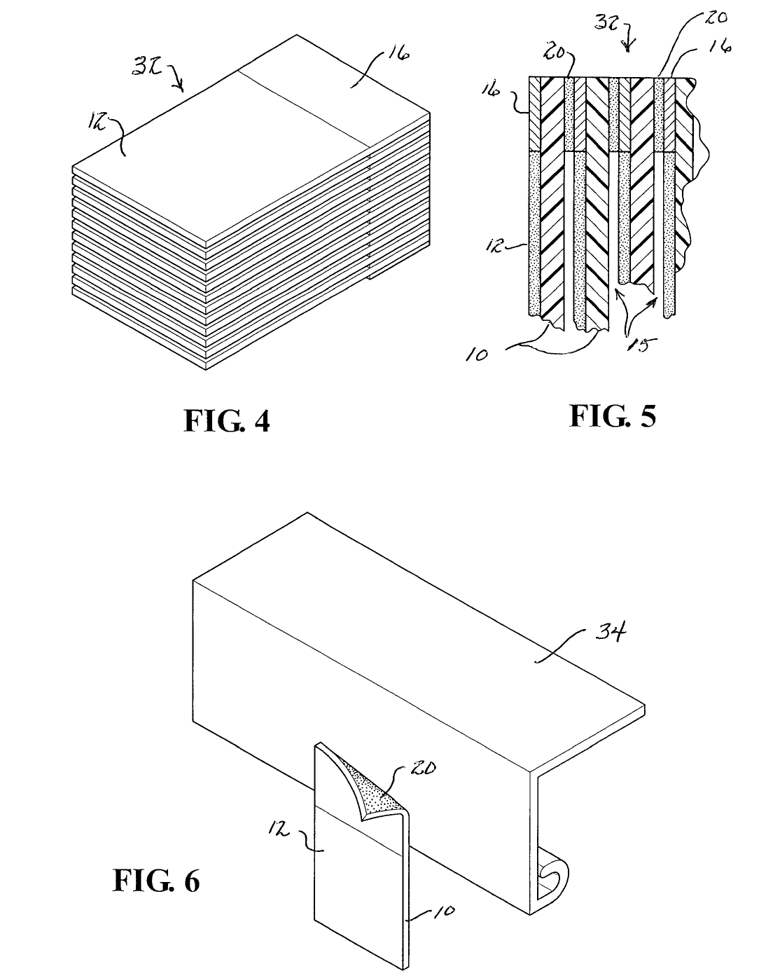

FIG. 4 shows a stack 32 of labels 10 after they have been printed and stacked. In one embodiment as shown in FIG. 4, there is a stack 32 consisting of twelve labels with the optional inkjet coating and a release coating 16 facing up. In alternative embodiments, the number of labels in stack 32 could be more or less than twelve. FIG. 5 shows a detailed sectional view of stack 32 with the front sides of label 10 stacked to the left. Each adhesive layer 20 directly overlies and conforms in dimension and shape to the underlying release coating 16, which can vary in size, to create a gap 15 between the back side of each label 10 and the optional inkjet coating 24 on the front side of the next adjacent label 10 in stack 32. This gap 15 allows each label 10 to be readily separated one from the other during the application process. In an alternative embodiment, the gap 15 is very small and probably not easily detectable because the adhesive thickness is only about ten percent of the thickness of face material 25.

The application process is represented in FIG. 6 where a label 10 is shown applied to the front side of a representative retail display/storage shelf 34. In this illustration, only the top ¼ to ⅓ of the label is shown adhered to the front side of the shelf 34 such that the label hangs straight down displaying the printing on the optional inkjet coating toward the consumer. Again, it will be understood that the rectangular label in the above-mentioned size is merely illustrative and that the labels may be of any size and/or shape as suits the needs or desires or the individual store.

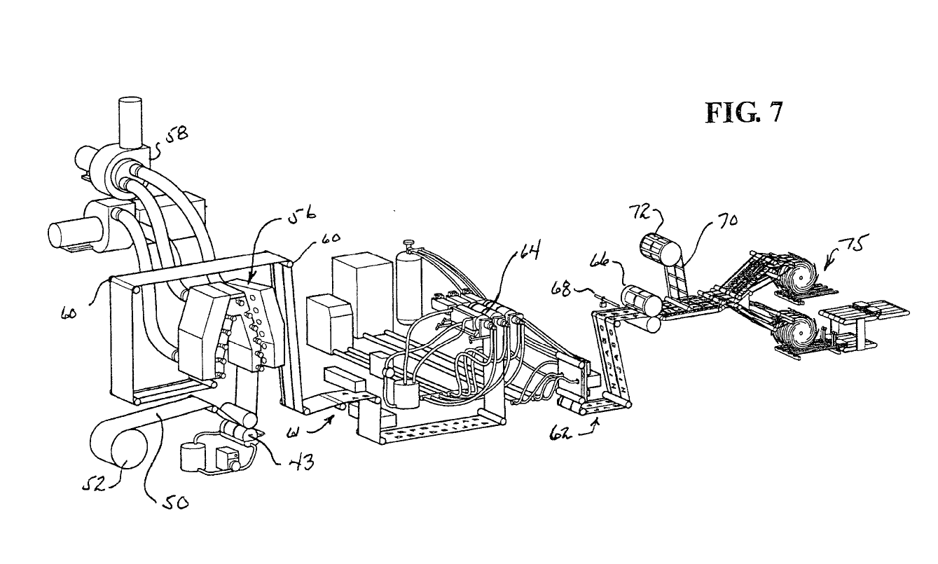

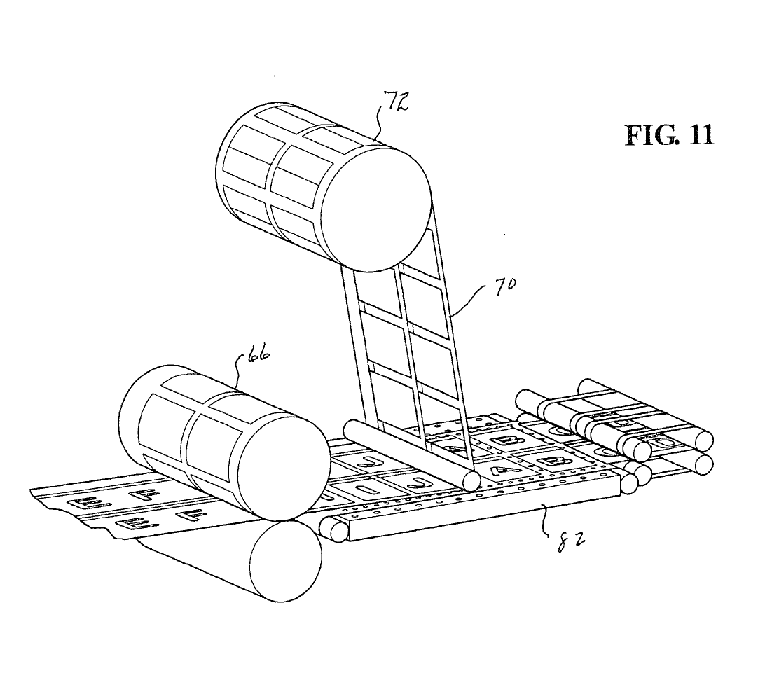

Referring now to FIGS. 7 through 11, an overall multi-station system is shown for making two parallel strips or rows of labels as described above from a double-wide strip of printable, flexible label stock 50 which is being taken from a supply roller 52 at the left side of the drawing. In this case, the label stock is wide enough to make two parallel rows of labels and also to leave a latticework of waste material (FIG. 11) after the labels are cut and removed from the material 50. A double-wide strip is chosen for purposes of illustration and not for limitation; i.e., the stock could be four wide, if desired.

The first station or step involves the passage of the strip 50 of material over an engraved cylinder 43 where two parallel transverse areas of adhesive are applied to one side only of the strip 50 of material. These areas of adhesive are applied at regularly spaced intervals; i.e., longitudinal spacing along the strip 50 and each strip has a relatively sharply defined top and bottom lateral edge. These areas are those shown in FIGS. 2, 3A, and 6 at 20. The material 50 with the strips or areas of adhesive applied then goes through a drying oven 56 which is attached to a hot air dryer 58. In the event a solid adhesive is used, drying is not needed.

After the adhesive-coated stock strip 50 emerges from the oven, it passes over a series of rollers 60 which carry the material over the top of the oven and from there to an inkjet printer 61. Again, the inkjet printer is representative of just one type of printer that can be used to apply information or indicia of some kind to the label material on the side opposite the adhesive.

After the printing step. The strip of stock then is conveyed to a second engraved cylinder 64 where liquid silicone is applied in pairs of lateral lines extending across the stock. These lateral lines are also regularly spaced as to correspond exactly to the lines or areas of adhesive but on the opposite side thereof. By way of further explanation, the lines of liquid silicone represent release coatings and the layers of silicon are identical in area, geometry and orientation to the lines of adhesive on the other side. To put even more clearly, the lines of silicone “register” with the lines of adhesive on the opposite side. However, as a practical matter, the lines of silicone-based release coating can be slightly larger than the lines of adhesive to make the manufacturing process easier. The release areas are those shown at 16 in FIG. 1 and at 28 in FIGS. 3 and 3A.

The silicone release material is cured at station 62 and then passes over a series of rollers to a die cutter 66 but first goes past a sensor 68 which locates the printing and/or other locator characteristic on the strip of stock to make sure that the die cutter cuts the labels free from the strip stock in exactly the right place so that the cut is in register with the digital and/or flexo printing.

This cutting step generates a matrix of waste material 70 which goes up to a roller 72 while the labels go to stacking stations 75 which are capable of producing two stacks of labels as shown in FIGS. 4 and 5. Two stacking stations are made possible with the use of a flapper to direct the labels to one or the other of the two stackers. When one of the stackers is full, a switch may be thrown to route the labels to the other stacker so that the previously-stacked labels can be removed and boxed.

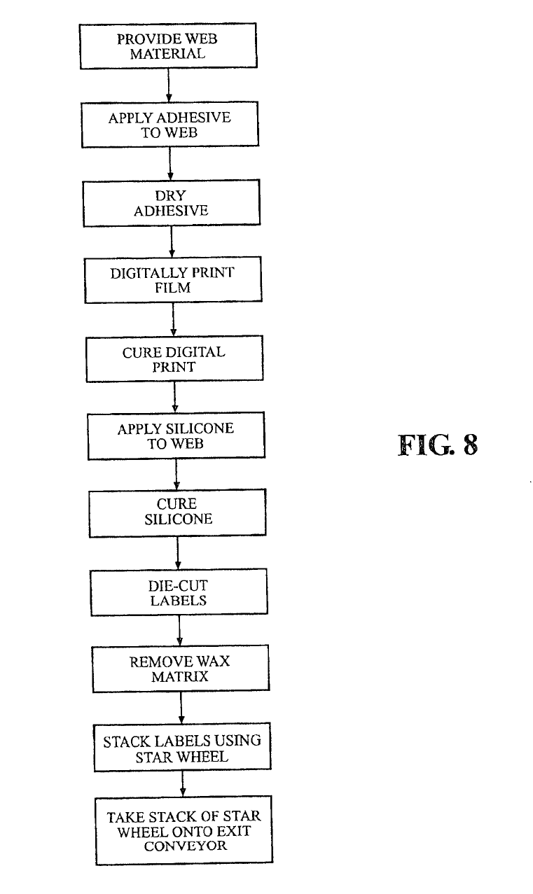

FIG. 8 is a block diagram of the various steps carried out in the various stations as described above. The step of providing a strip or web of material is shown in FIG. 7 at 52, while the step of applying adhesive is shown at 43. The third step of drying the adhesive is shown at 56; the next step is one of printing on the label stock at station 61; the next step is one of curing the printing as necessary; the next step is applying the silicone release strips to the stock at station 64; the next step is curing the silicone release at station 62; the next step is to cut the labels into individual shape at station 66, in this case shown as rectangular, for purposes of illustration only. The next step is to remove the waste matrix 70 and roll it up for recycling if possible. The final step is the stacking of the labels using starwheel stackers at station 75. There is a vacuum box 82 that holds the labels in place where they enter the stacking apparatus; i.e., starwheel stackers.

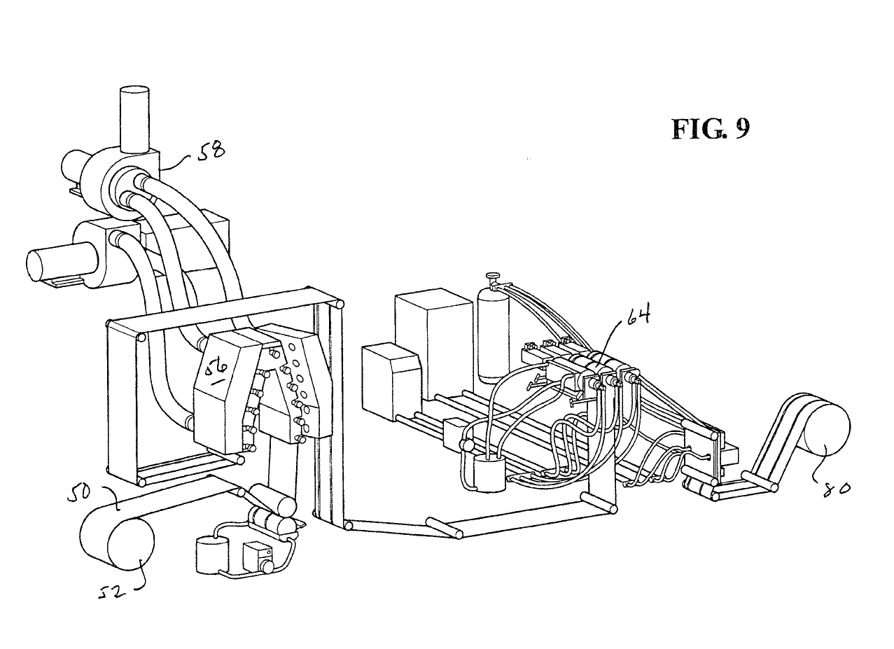

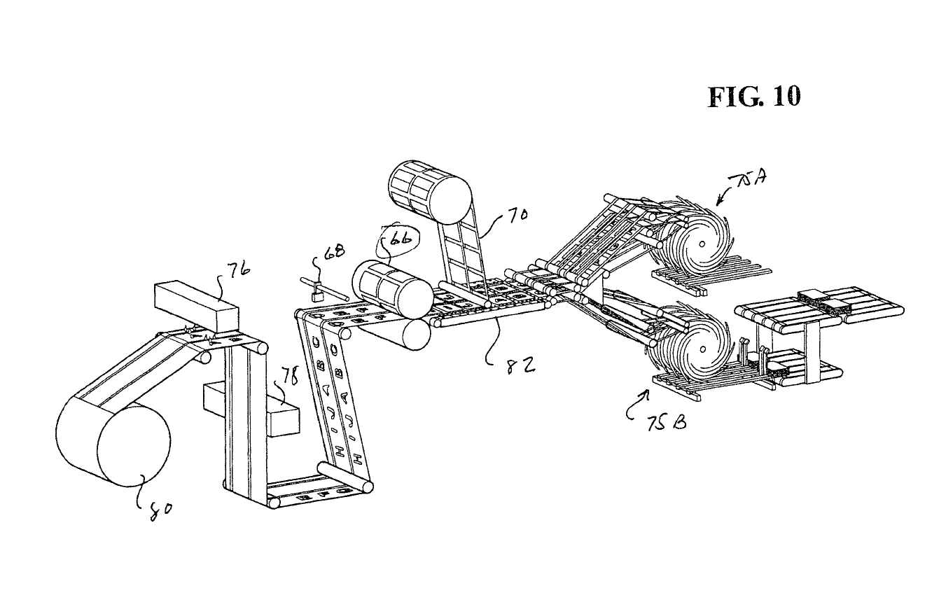

Referring now to FIGS. 9 and 10, these drawings are nearly duplicative of each of the beginning and ending portions of the overall system of FIG. 7 and show how the overall process may, for practical purposes, be divided into two parts which can be carried out in the same plant or in different plants by different people. The system of FIG. 9 produces a strip of double-wide label stock with adhesive and silicone applied as described above but without printing, cutting or stacking. The result is a roll 80 of label stock.

Referring to FIG. 10, the roll 80 of label stock is the feed product which first goes to the printing station 76. It then goes past a UV curing station 78. From this, the double-wide printed label stock goes to a sensor 68 for registration purposes to determine exactly where the label stock is to be cut and from there, the label stock passes through the engraved cutting cylinder 66 to die-cut the labels. The matrix 70 of waste is then separated and goes up to the roller 72 while the individual double rows of labels proceed forward to the two alternately employed starwheel stackers 75A and 75B.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of making labels from a strip of printable, flexible sheet stock having first and second opposed sides comprising the steps of:
a. Applying discreet layers of adhesive at regularly spaced intervals along a first side of said strip, said layers being of identical area, geometry, and orientation;
b. Applying discreet layers of silicone-based release coating at regularly spaced intervals along a second side of said strip, said discreet release coating layers being of identical area, geometry, and orientation as said adhesive layers and positionally in registry with said adhesive layers but on the opposite side of said strip stock so that said at least one edge of each adhesive layer substantially directly overlies the corresponding edge of a release layer; and
c. Curing the release layers.

2. The method of claim 1 including the further step of printing on said second side of the strip of label stock at regularly-spaced intervals between said release layers.

3. The method of claim 2 including the further step of:
d. Cutting the strip of label stock in individual labels at regularly spaced intervals along said strip in register with the printing.

4. The method of claim 3 wherein the steps of applying adhesive, release coating, and printing are all carried out in a substantially continuous repeating fashion on a moving strip of label stock and including the further step of:
e. Sensing the position of the printing and locating the cutting step according to the position of the printing.

5. The method of claim 4 including the further step of rolling up a continuous matrix of waste produced by the cutting step.

6. A stack of labels made according to the process defined in claim 5 wherein the release and adhesive areas of the respective labels directly overlie each other in the stack.

7. A method of making stacks of adhesive labels from a strip of label stock comprising the steps of:
a. passing the strip stock through an adhesive station to apply identical areas to longitudinally spaced stations along one side of the stock;
b. passing the strip stock through a release coating station to apply identical areas of release coating to longitudinally spaced locations along another side of the stock; the adhesive and release coating locations being substantially aligned with one another;
c. cutting the stock into individual labels so that the locations are at one end of the cut labels; and
d. stacking the cut labels on top of another with the adhesive locations directly on top of the release coating locations.

8. The method of claim 7 further including the step of printing product information between the release coating locations.

9. A stack of labels made according to the method of claim 8.

10. A stack of ready to use adhesive labels comprising:
a plurality of layers of label stock pieces in overlying and registering relationship with one another;
each of said label stock pieces having, on a first side, a minor area coated with release material and a major area of uncoated stock with printing on a portion thereof;
each of said label stock pieces having on a second side opposite the first side a minor area coated with an adhesive substantially directly opposite and in registry with the area of release material on the first side;
said plurality of pieces being assembled into a stack by overlaying the release area of each piece with the adhesive area of the next piece in the stack.
